(19) United States
(12) Patent Application Publication
(10) Pub. No.: US 2009/0052940 A1
(43) Pub. Date: Feb. 26, 2009

(54) IMAGING CARTRIDGE AND IMAGE FORMING APPARATUS

(75) Inventors: Hiroshi Mizuno, Aisai-shi (JP); Isamu Kugimiya, Toyokawa-shi (JP); Takeshi Hashimoto, Okazaki-shi (JP); Naoto Yoshida, Toyokawa-shi (JP); Nozomu Kondo, Toyokawa-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/187,024

(22) Filed: Aug. 6, 2008

(30) Foreign Application Priority Data
Aug. 23, 2007 (JP) 2007-216670

(51) Int. Cl. G03G 15/08

(52) U.S. Cl. 399/120

(57) ABSTRACT

An imaging cartridge is detachably loaded into an image forming apparatus body. A process unit has a developing device for developing an electrostatic latent image on a photoconductor to form a toner image, and a cleaning device for collecting toner remaining on the image bearing body even after transfer of the toner image. A new toner box is detachably attached to the process unit and serves for storing therein unused toner fed to a developing device. A waste toner box is detachably attached to the process unit and serves for storing therein waste toner collected by the cleaning device. A support mechanism couples the new toner box and the waste toner box to each other so as to be supported each other in a manner allowing elastic relative displacement.

### RELATED APPLICATION

This application based on Japanese Patent Application No. 2007-216670 the contents in which are incorporated herein by reference.

### BACKGROUND OF THE INVENTION

The present invention relates to an imaging cartridge used for image forming apparatuses such as copying machines, facsimile machines, printers, and multi-functional machines.

For enhancing maintenanceability, an imaging cartridge has been known which can be loaded into and unloaded from an image forming apparatus body by providing such devices as an image bearing body, a charging device, a developing device, a transfer device, a cleaning device in the form of cartridges (see, e.g., Japanese Patent Application Laid-Open Publication 2006-267922). In this kind of imaging cartridge, with respect to a new toner box for storing unused toner to be fed to the developing device and a waste toner box for storing waste toner collected by the cleaning device, the following three aspects are generally known.

In the first aspect, the waste toner box is a consumable item independent of the imaging cartridge. In the second aspect, both of the new toner box and waste toner box are integrated with the imaging cartridge. In the third aspect, the new toner box is a consumable item independent of the imaging cartridge.

However, the first and third aspects increase the number of consumable items, resulting in complicates replacement procedures. Further, the second aspect requires replacement of the imaging cartridge for such reasons as exhaustion of the toner in the new toner box (toner empty) and the waste toner filling of the waste toner box (waste toner full) even if expensive components included in the imaging cartridge have not yet expired in life, thereby causing increase in total cost for ownership (TCO).

In order to solve these problems, it would be conceivable that the imaging cartridge is so structured as to have a new toner box and a waste toner box in a detachable manner to achieve both of the simplification of consumable item replacement procedures and the reduction in TCO. However, in adopting this structure, it is indispensable to secure the setting property as well as the positioning accuracy of the new toner box and the waste toner box.

### SUMMARY OF THE INVENTION

Accordingly, an object of the present invention is to provide an imaging cartridge having a new toner box and a waste toner box in a detachable manner and enabled to achieve successful setting property and high positioning accuracy of the new toner box and the waste toner box.

A first aspect of the present invention provides an imaging cartridge which is detachably loaded into an image forming apparatus body, including: a process unit including at least an image bearing body, a developing device for developing an electrostatic latent image on the image bearing body to form a toner image, and a cleaning device for collecting toner remaining on the image bearing body even after transfer of the toner image; a new toner box which is detachably attached to the process unit and which serves for storing therein unused toner fed to the developing device;

a waste toner box which is detachably attached to the process unit for storing therein waste toner collected by the cleaning device; and a support mechanism for coupling the new toner box and the waste toner box to each other in a manner allowing elastic relative displacement so that the new toner box and the waste toner box support each other.

Since there is provided a toner replenishment type imaging cartridge having the new toner box and the waste toner box which can be attached to and detached from the process unit, the process unit generally including expensive components can be used as long as possible, thereby allowing reduction in TCO.

Moreover, since the new toner box and the waste toner box are detachably attached to the process unit, the attaching and detaching procedures of the new toner box and the waste toner box, which are consumable items, to/from the image forming apparatus body are simple and easy to understand.

The new toner box and the waste toner box are coupled to each other by the support mechanism in a manner allowing elastic relative displacement so as to support each other. Accordingly, when the imaging cartridge is loaded into the image forming apparatus body, at least one of the new toner box and the waste toner box is enabled to retreat from an original position, so that successful setting property of the new toner box and the waste toner box onto the image forming apparatus body is achieved.

Also, the new toner box and the waste toner box are elastically displaceable relative to each other by the support mechanism, and the elastic pressing force exerted by the support mechanism on the new toner box and the waste toner box contributes to their positioning with respect to the process unit. Therefore, the new toner box and the waste toner box are positioned with respect to the process unit with high degree of accuracy, which leads to stabilization of imaging quality.

A second aspect of the present invention provides an image forming apparatus including the above-mentioned imaging cartridge.

According to the imaging cartridge in the present invention, it becomes possible to accomplish both the simplification of replacement procedures of the new toner box and the waste toner box, which are consumable items, and the reduction in TCO, while accomplishing improvement in the setting property and the positioning accuracy of the new toner box and the waste toner box, simplification of the mechanism of the image forming apparatus body, reduction in loss of the pressing force to the developing device, and the like.

### BRIEF DESCRIPTION OF THE DRAWINGS

Other objects and characteristics of the present invention shall be clarified by the following description on the preferred embodiments with reference to the accompanying drawings.

FIG. 1 is a cross sectional view showing an image forming apparatus including an imaging cartridge according to a first embodiment of the present invention;

FIG. 2 is a cross sectional view showing the image forming apparatus with a rear section opened;

FIG. 3 is a cross sectional view showing the imaging cartridge according to the first embodiment of the present invention;

FIG. 4 is a perspective view showing the imaging cartridge according to the first embodiment of the present invention;

FIG. 5 is an exploded perspective view showing the imaging cartridge according to the first embodiment of the present invention;

FIG. 6 is a partial cross-sectional view taken along a line IV-IV of FIG. 4;

FIG. 7 is a partial cross-sectional exploded perspective view showing the imaging cartridge according to the first embodiment of the present invention with a part of its components removed;

FIG. 8 is a partial cross-sectional exploded perspective view showing the imaging cartridge according to the first embodiment of the present invention with a part of its components removed;

FIG. 9 is a schematic cross-sectional view for explaining operation of shutters for waste side toner delivery and reception openings;

FIG. 10 is a schematic cross-sectional view for explaining operation of the shutters for development side toner delivery and reception openings;

FIG. 11A is a schematic cross-sectional view showing attachment of a toner box to a process unit according to the first embodiment of the present invention;

FIG. 11B is a schematic cross-sectional view showing loading of the imaging cartridge into the image forming apparatus body according to the first embodiment of the present invention;

FIG. 12 is a cross sectional view showing an imaging cartridge according to a second embodiment of the present invention;

FIG. 13 is a perspective view showing the imaging cartridge according to the second embodiment of the present invention;

FIG. 14 is an exploded perspective view showing the imaging cartridge according to the second embodiment of the present invention;

FIG. 15 is a partial cross-sectional view taken along a line XV-XV of FIG. 13;

FIG. 16A is a schematic cross-sectional view showing attachment of a toner box to a process unit according to the second embodiment of the present invention;

FIG. 16B is a schematic cross-sectional view showing loading of the imaging cartridge into the image forming apparatus body according to the second embodiment of the present invention;

FIG. 17 is an exploded perspective view as viewed from above showing an imaging cartridge according to a third embodiment of the present invention; and

FIG. 18 is an exploded perspective view showing the imaging cartridge in the third embodiment of the present invention as viewed from below.

### DETAILED DESCRIPTION OF THE PREFERRED EMBODIMENTS

Embodiments of the present invention will now be described with reference to the accompanying drawings.

### First Embodiment

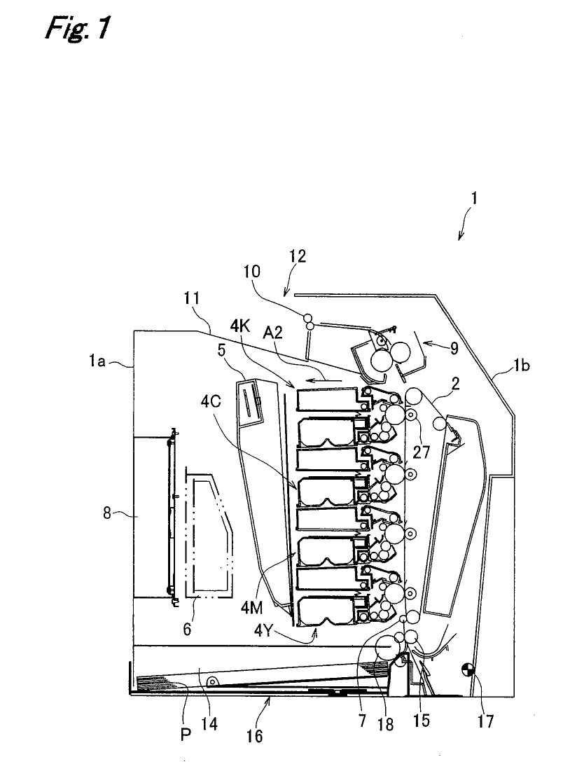

FIG. 1 shows an image forming apparatus (tandem-type color laser printer) 1 having an imaging cartridge according to a first embodiment of the present invention.

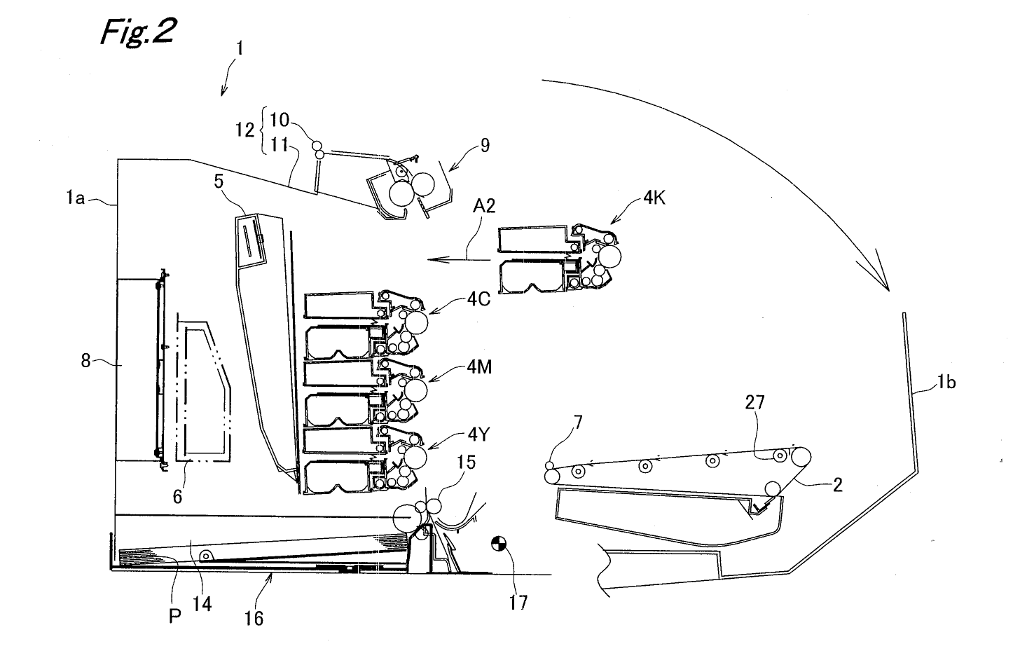

Arranged inside an apparatus main frame 1a of the image forming apparatus 1 is a transfer belt 2 stretched over a plurality of rollers. Also in the apparatus main frame 1a, four imaging cartridges 4Y, 4M, 4C and 4K of yellow, magenta, cyan and black are arranged in the longitudinal direction on a rear-face side of the apparatus main frame 1a (left-hand side in FIG. 1) with respect to the transfer belt 2. Further, accommodated in the apparatus main frame 1a on a further rear-face side from the imaging cartridges 4Y to 4K are, a laser exposure device 5, an electric power unit 6 for supplying electric power to the entire apparatus, and a control device 8 for controlling operation of each section. Placed on an upper side of the apparatus main frame 1a are a fixing device 9 and a paper ejection device 12 composed of a paper ejection roller 10 and a paper ejection tray 11. A sheet feeding device 16 having a paper cassette 14 and a feed roller 18 is arranged on a lower side of the apparatus main frame 1a. The paper cassette 14 can be attached to and detached from a front-face side of the apparatus main frame 1a (right-hand side in FIG. 1). A door 1b which can be rotated around a pivot 17 so as to be openable and closable is provided on the front-face side of the apparatus main frame 1a, and the transfer belt 2 is placed in the door 1b. As shown in FIG. 2, as the door 1b is opened, the transfer belt 2 is put in a escape position, where the imaging cartridges 4Y to 4K can be loaded into and unloaded from the front-face side of the apparatus main frame 1a.

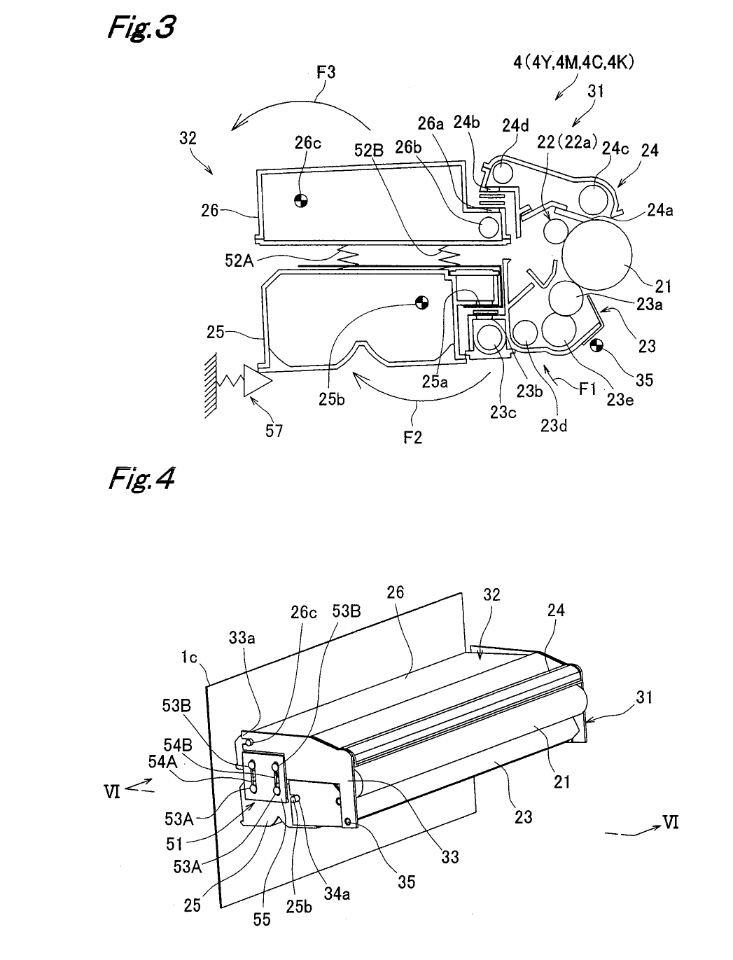

Also with reference to FIG. 3, each of the imaging cartridges 4Y to 4K is provided with a cylindrical photoconductor (image bearing body) 21 provided in a rotatable manner as well as a charging device 22, a developing device 23, and a cleaning device 24 which are arranged around the photoconductor 21. Moreover, each of the imaging cartridges 4Y to 4K is provided with a new toner box 25 for storing unused toner and a waste toner box 26 for storing waste toner. Toner corresponding to one among yellow, magenta, cyan, and black is stored in the new toner box 25 of each of the imaging cartridges 4Y to 4K. The transfer device 27 is arranged so as to face the photoconductor 21 of each of the imaging cartridges 4Y to 4K across the transfer belt 2 (see FIGS. 1 and 2).

Brief description is now given of the process in each of the imaging cartridges 4Y to 4K. First, the photoconductor 21 is charged by the charging device 22, and then is irradiated with a laser beam from the laser exposure device 5 to form an electrostatic latent image on the photoconductor 21 according to image signals. With the toner fed from the new toner box 25, the developing device 23 develops the electrostatic latent image on the photoconductor 21 to form a toner image. Toner that remains on the photoconductor 21 even after transfer of the toner image to a paper sheet or recording medium “P” by the transfer device 27 is collected by the cleaning device 24 and stored in the waste toner box 26.

The image forming apparatus 1 is a type in which the recording medium “P” is fed from the paper sheet cassette 14 to the front-face side and transported upward with an image being formed thereon meanwhile, and then discharged to the rear-face side. More specifically, the recording medium “P” is sent out from the paper sheet cassette 14 to the front-face side sheet by sheet by the feed roller 18, electrostatically held by the transfer belt 2 after passing through a timing roller 15 and conveying roller 7, and then transported upward. Whenever the recording medium “P” passes between the photoconductor 21 and the transfer device 27 in each of the imaging cartridges 4Y to 4K, a toner image of one color is electrostatically transferred thereon. The recording medium “P” with toner images transferred thereon in superimposition one on another by the imaging cartridges 4Y to 4K is transported to the fixing device 9 for fixing the toner image by heating and pressurization, and then the recording medium “P” is discharged by the paper ejection roller 10 to the paper ejection tray 11.

Description is now given of the imaging cartridges 4Y to 4K in detail. Hereinafter, when it is not necessary to distinguish four imaging cartridges 4Y to 4K, reference numeral “4” is used to denote the imaging cartridge.

With reference to FIG. 3 through FIG. 5, the imaging cartridge 4 of the present embodiment comprises a process unit 31 and toner box unit 32. The toner box unit 32 is detachably attached to the process unit 31.

The process unit 31 comprises the photoconductor 21, charging device 22, developing device 23, and cleaning device 24. The cleaning device 24 comprises a cleaning blade 24a for collecting toner from the surface of the photoconductor 21, a waste side toner delivery opening 24b provided in a position away from the photoconductor 21 and opened downward, and a conveying roller 24c and conveying screw 24d for transporting the toner collected by the cleaning blade 24a to the waste side toner delivery opening 24b. The charging device 22 has a charging roller 22a for charging. The developing device 23 comprises a developing roller 23a, development side toner reception opening 23b provided in a position away from the developing roller 23a and opened upward, and a conveying screw 23c and conveying rollers 23d, 23e for transporting toner from the development side toner reception opening 23b to the developing roller 23a.

Moreover, the process unit 31 comprises a first casing 33 rotatably supports the photoconductor 21 and accommodates the charging device 22 and the cleaning device 24, and a second casing 34 for accommodating the developing device 23. The second casing 34 is coupled to the first casing 33 so as to be rotatable around a pivot 35. The first casing 33 and the second casing 34 are connected to each other with an unshown spring. The spring elastically presses the second casing 34 in a direction of bringing the developing roller 23a closer to the photoconductor 21 (an arrow “F1” in FIG. 3). An unshown ring component for gap adjustment is mounted on the shaft of the developing roller 23a. By pressing the ring component toward the first casing 33 side with the pressing force “F1”, the developing roller 23a faces the photoconductor 21 with a desired gap.

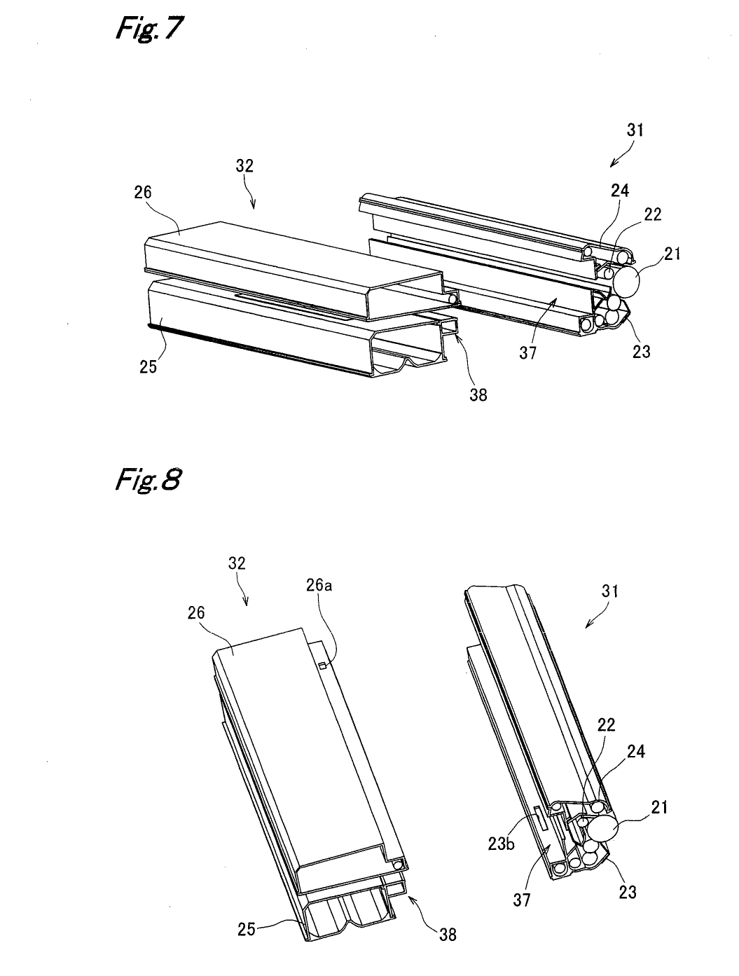

As most clearly shown in FIGS. 7 and 8, a reception space 37 is provided in a portion of the process unit 31 on its one side opposite to the photoconductor 21. The reception space 37 is a horizontally long space with its upper end being defined by a portion near the waste side toner delivery opening 24b of the cleaning device 24, and its lower end being defined by a portion near the development side toner reception opening 23b of the developing device 23. By insertion of a later-described insertion section 38 provided on the toner box unit 32 into the reception space 37, the toner box unit 32 is detachably attached to the process unit 31.

The toner box unit 32 comprises the new toner box 25 and waste toner box 26 detachably attached to the process unit 31. Since the imaging cartridge 4 is a toner replenishment type cartridge in which the new toner box 25 and waste toner box 26 can be attached to and detached from the process unit 31, the process unit 31 generally including expensive components can be used as long as possible, thereby allowing reduction in TCO. Moreover, since the new toner box 25 and waste toner box 26 are detachably attached to the process unit 31, the attaching and detaching procedures of the new toner box 25 and waste toner box 26, which are consumable items, with respect to the image forming apparatus body 1a are simple and easy to understand.

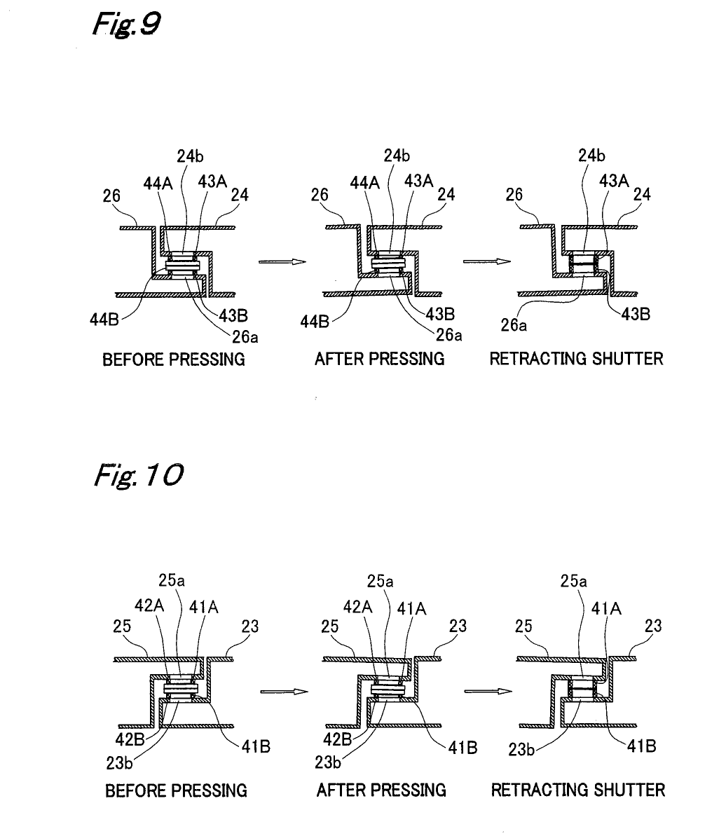

The waste toner box 26 is a box for storing therein the waste toner collected by the cleaning device 23. The waste toner box 26 has a waste side toner reception opening 26a opened upward in a portion positioned under the waste side toner delivery opening 24b of the cleaning device 24 at the time of its attachment to the process unit 31. A conveying screw 26b is arranged near a lower side of the waste side toner reception opening 26a. With reference to FIG. 9, sealing members 43A and 43B similar to those of the development side toner delivery opening 25a and development side toner reception opening 23b are respectively attached to the waste side toner delivery opening 24b and waste side toner reception opening 26a. The process unit 31 and waste toner box 26 have waste side shutters 44A and 44B which interlock with each other. By retracting the waste side shutters 44A and 44B from an area between the sealing members 43A and 43B, the waste side toner delivery opening 24b and waste side toner reception opening 26a can be communicated with each other.

The new toner box 25 is a box for storing therein unused toner to be fed to the developing device 23. The new toner box 25 has a development side toner delivery opening 25a opened downward in a positioned above the development side toner reception opening 23b of the developing device 23 at the time of its attachment to the process unit 31. An unshown conveying screw is arranged near the upper side of the development side toner delivery opening 25a. With reference to FIG. 10, attached respectively to the development side toner delivery opening 25a and the development side toner reception opening 23b are elastically deformable sealing members 41A and 41B having through holes formed therein and made of such material as urethane. The process unit 31 and the new toner box 25 have development side shutters 42A and 42B interlock with each other. By retracting the development side shutters 42A and 42B from an area between the sealing member 41A and 41B, the development side toner delivery opening 25a and development side toner reception opening 23b can be communicated with each other.

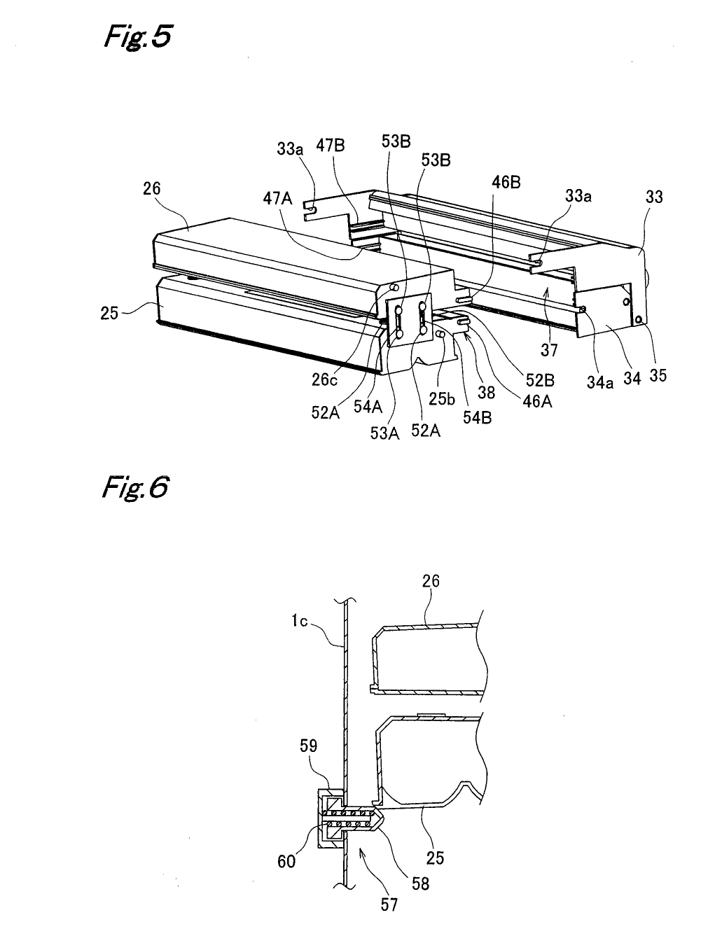

A portion near the development side toner delivery opening 25a of new toner box 25 and a portion near the waste side toner reception opening 26a of waste toner box 26 constitute the insertion section 38 to be inserted into the reception space 37 provided on the process unit 31. As shown in FIG. 5, guide linear protrusions 46A and 46B protrude on both side portions of the insertion section 38 of the new toner box 25 and waste toner box 26. Corresponding to the guide linear protrusion 46A on the new toner box 25 side (lower side), a pair of guide grooves 47A are formed in an internal surface of the second casing 34 of the process unit 31. Corresponding to the guide linear protrusion 46B on the waste toner box 26 side (upper side), a pair of guide grooves 47B are formed in an internal surface of the first casing 33 of the process unit 31.

The toner box unit 32 has a support mechanism 51 for coupling the new toner box 25 and the waste toner box 26 to each other so as to be supported to each other in a manner allowing elastic relative displacement between the new toner box and waste toner box 26. With reference to FIG. 3 through FIG. 5, the support mechanism 51 has two pairs of helical compression springs 52A and 52B. Each of the helical compression springs 52A and 52B is so structured that its upper end side is connected to a lower surface of the waste toner box 26 while its lower end side is connected to an upper surface of the new toner box 25. These compression springs 52A and 52B elastically bias the new toner box 25 and waste toner box 26 in a direction where the new toner box 25 and waste toner box 26 are displaced away from each other. Moreover, the support mechanism 51 comprises pairs of stepped screws 53A and 53B fixed in each one pair on both side sections of the new toner box 25 and the waste toner box 26, and a pair of coupling plates 55 having guide grooves 54A and 54B extending in a vertical direction with both ends being closed. The stepped screws 53A and 53B are respectively inserted in the guide grooves 54A and 54B, thereby limiting a range of the relative displacement of the new toner box 25 and waste toner box 26.

As most clearly shown in FIGS. 3 and 5, a development side rotating pivot 25b projecting in the lateral direction is provided on each of both side sections of the new toner box 25 at a portion adjacent to the development side toner delivery opening 25a (portion on the insertion section 38 side). Further, a waste side rotating pivot 26c projecting in the lateral direction is provided on each of both side sections of the waste toner box 26 at a portion away from the waste side toner reception opening 26a (portion away from the insertion section 38).

On each of both side sections of the reception space 37, a development side recess hole 34a for receiving the development side rotating pivot 25b is formed in the second casing 34 of the process unit 31. Further, on each of both side sections of the reception space 37, a waste side recess hole 33a for receiving the waste side rotating pivot 26c is formed in the first casing 33 of the process unit 31. The development side recess hole 34a and waste side recess hole 33a are opened at their one end and closed at their other end. Upon attachment of the toner box unit 32 to the process unit 31, the closed ends of the development side recess hole 34a and waste side recess hole 33a function as bearings for rotatably supporting the development side rotating pivot 25b and waste side rotating pivot 26c.

As shown in FIGS. 3 and 6, the apparatus main frame 1a is provided with a first pressing mechanism 57 for elastically biasing the new toner box 25. The first pressing mechanism 57 comprises a presser 58 slidably inserted into a through hole provided in a wall 1c inside the apparatus main frame 1a, a spring retainer 59 fixed to the wall 1c, and a helical compression spring 60 compressively provided between the presser 58 and the spring retainer 59.

Description is now given of the procedures for attaching the toner box unit 32 to the process unit 31 and further loading the imaging cartridge 4 onto the apparatus main frame 1a.

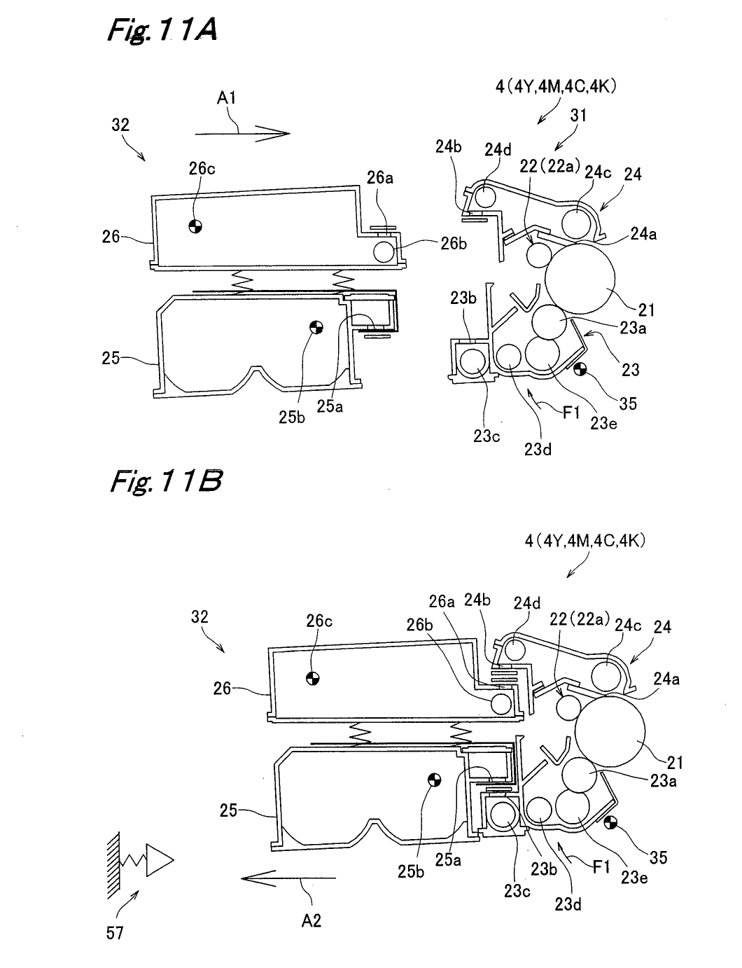

With reference to FIG. 11A, as shown by an arrow “A1”, the insertion section 38 of the toner box unit 32 is inserted into the reception space 37 of the process unit 31. During the insertion, the guide linear protrusions 46A and 46B of the toner box unit 32 are guided by the guide grooves 47A and 47B of the process unit 31, so that the toner box unit 32 is attached to the process unit 31 with maintaining its right posture. The development side rotating pivot 25b and waste side rotating pivot 26c respectively enter the development side recess hole 34a and waste side recess hole 33a. Upon complete insertion of the insertion section 38 into the reception space 37, the development side rotating pivot 25b and waste side rotating pivot 26c respectively reach the closed ends of the development side recess hole 34a and waste side recess hole 33a, by which the attachment of the toner box unit 32 to the process unit 31 is completed. In such a state that the attachment of the toner box unit 32 to the process unit 31 has been completed as described above, the position of the new toner box 25 and waste toner box 26 with respect to the process unit 31 is temporarily or preliminarily determined. More specifically, since the new toner box 25 and waste toner box 26 are coupled together by the support mechanism 51 in a manner allowing elastic relative displacement, the new toner box 25 and waste toner box 26 are attached to the process unit 31 in the state of being allowed for changes in position and posture.

Next, as shown by an arrow “A2” in FIGS. 1 and 11B, the imaging cartridge 4 is loaded into the apparatus main frame 1a. With reference to FIG. 3, when the imaging cartridge 4 is inserted into a predetermined position in the apparatus main frame 1a, a portion of the lower portion of the new toner box away from the development side toner delivery opening 25a (portion away from the insertion section 38), i.e., the portion positioned on the left-hand side of the development side rotating pivot 25b, is pressed upward by the first pressing mechanism 57 of the apparatus main frame 1a. By the elastic pressing force exerted by the first pressing mechanism 57, the new toner box 25 rotates around the development side rotating pivot 25b. More specifically, as shown by an arrow “F2” in FIG. 3, with the pressing force exerted by the first pressing mechanism 57, the new toner box 25 rotates around the development side rotating pivot 25b in the direction in which the vicinity of the development side toner delivery opening 25a is biased toward the vicinity of the development side toner reception opening 23b of the developing device 23 (clockwise direction in FIG. 3). As a result, the position of the new toner box 25 with respect to the process unit 31 is determined.

As the new toner box 25 rotates around the development side rotating pivot 25b in the direction of the arrow “F2”, the helical compression springs 52A and 52B of the support mechanism 51 are compressed. As a result, a portion on the lower surface side of the waste toner box 26, the portion being positioned on the left-hand side of the waste side rotating pivot 26c, is pressed upward by these helical compression springs 52A and 52B. By the elastic pressing force exerted by the support mechanism 51, the waste toner box 26 rotates around the waste side rotating pivot 26c. More specifically, as shown by an arrow “F3” in FIG. 3, with the pressing force exerted by the support mechanism 51, the waste toner box 26 rotates around the waste side rotating pivot 26c in the direction in which the vicinity of the waste side toner reception opening 26a is biased toward the vicinity of the waste side toner delivery opening 24b of the cleaning device 24 (counterclockwise direction in FIG. 3). As a result, the position of the waste toner box 26 with respect to the process unit 31 is determined.

In addition to the accomplishment of both the simplification of the replacement procedures for consumable items, i.e., the new toner box 25 and waste toner box 26 and the reduction in TCO as mentioned above, the imaging cartridge 4 of the present embodiment has following characteristics or advantages.

First, the new toner box 25 and waste toner box 26 are coupled to each other by the support mechanism 51 so as to be supported to each other in a manner allowing elastic relative displacement. Accordingly, when the imaging cartridge 4 is loaded into the image forming apparatus body 1a, the new toner box 25 and waste toner box 26 are enabled to temporarily retreat or escape from an original position, thereby achieving successful setting property of the new toner box 25 and waste toner box 26 on the image forming apparatus body 1a.

Next, the new toner box 25 and waste toner box 26 are elastically displaceable relative to each other by the support mechanism 51, and the elastic force exerted by the helical compression springs 52A and 52B of the support mechanism 51 on the new toner box 25 and waste toner box 26 contributes to the positioning of the new toner box 25 and waste toner box 26 with respect to the process unit 31. Therefore, the new toner box 25 and waste toner box 26 are positioned with respect to the process unit 31 with high degree of accuracy, thereby casing stabilization of imaging quality.

As mentioned above, the new toner box 25 is urged to be rotated around the development side rotating pivot 25b in the direction where the development side toner delivery opening 25a is biased toward the development side toner reception opening 23b of the developing device 23. This maintains high degree of contact tightness of the development side toner delivery opening 25a to the development side toner reception opening 23b, thereby preventing leakage and littering of the unused toner. Similarly, the waste toner box 26 is urged to be rotated around the development side rotating pivot 25b in the direction where the waste side toner reception opening 26a is biased toward the waste side toner delivery opening 24b of the cleaning device 24. This maintains high degree of contact tightness of the waste side toner reception opening 26a to the waste side toner delivery opening 24, thereby preventing leakage and littering of the waste toner.

Further, while the portion of the lower portion of the new toner box 25 away from the development side toner delivery opening 25a is pressed upward by the first pressing mechanism 57 on the apparatus main frame 1a side, the development side rotating pivot 25b of the new toner box 25 is accommodated in the development side recess hole 34a provided in the second casing 34 including the developing device 23. Accordingly, the pressing force exerted by the first pressing mechanism 57 on the new toner box 25 is transmitted to the second casing 34 as the force acting in the direction of bringing the developing roller 23a of the developing device 23 closer to the photoconductor 21 (in the direction of arrow F1 of FIG. 3). Therefore, there is no loss of the pressing force exerted on the developing device 23 due to the pressing force acting on the new toner box 25 from the first pressing mechanism 57 on the image forming apparatus body 1a side, so that the positioning accuracy of the developing device 23 with respect to the photoconductor 21 can be secured, thereby causing stabilization of imaging quality.

Furthermore, only one first pressing mechanism 57 needs to be provided on the image forming apparatus body 1a side for positioning of the new toner box 25 and waste toner box 26, so that the mechanism of the image forming apparatus body 1a can be simplified.

### Second Embodiment

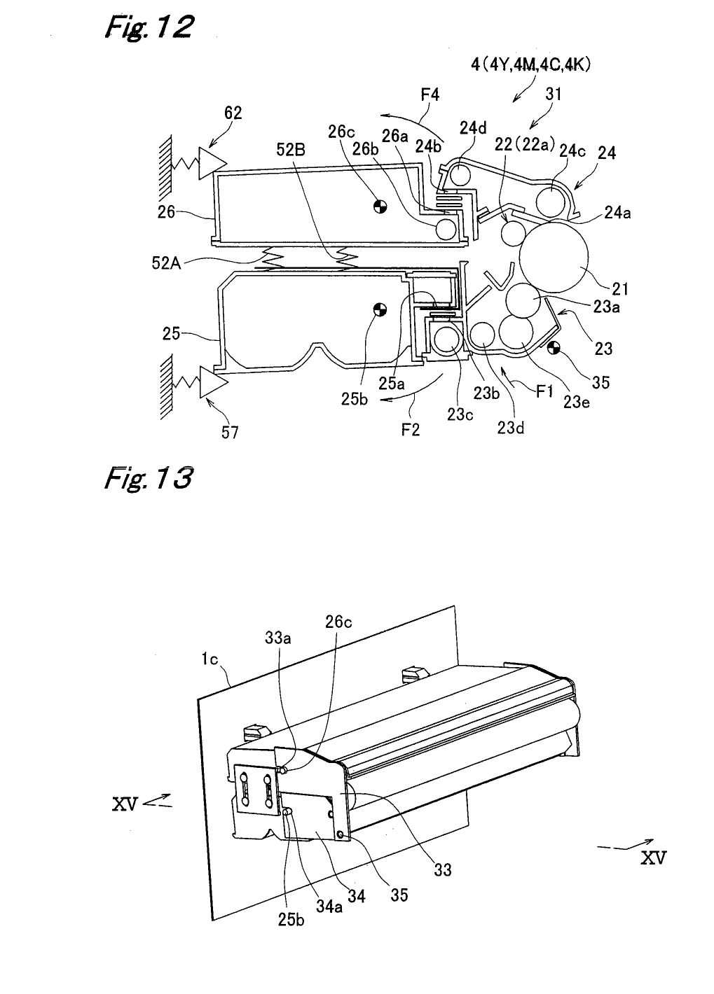

FIG. 12 to FIG. 15 show an imaging cartridge 4 according to a second embodiment of the present invention. In the present embodiment, a plurality of pressing mechanisms 57 and 62 are provided on the apparatus main frame 1a side.

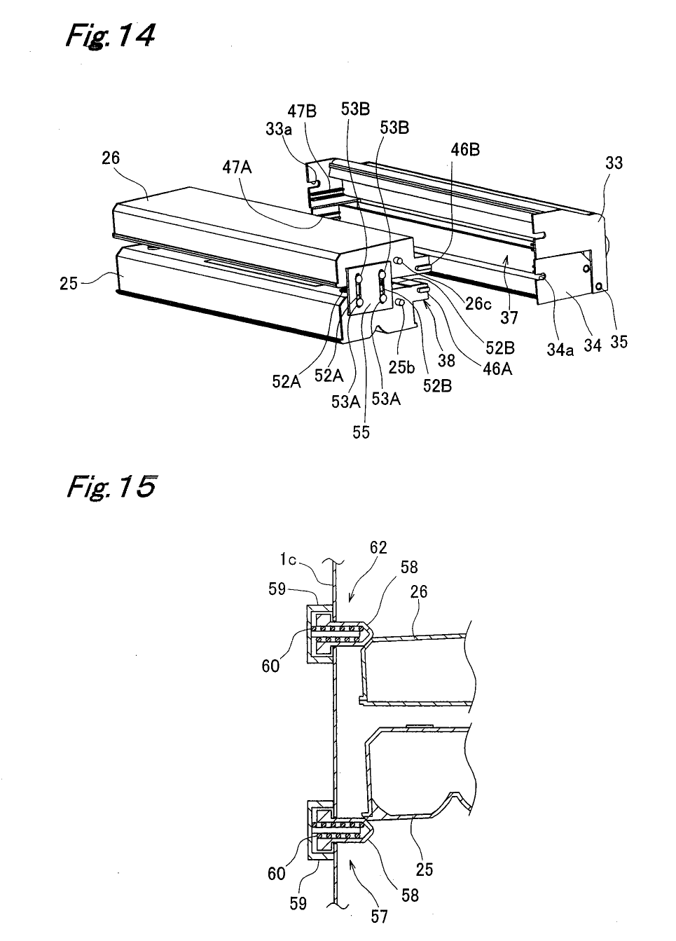

As most clearly shown in FIGS. 12 and 14, a development side rotating pivot 25b of the new toner box 25 is provided in the portion adjacent to the development side toner delivery opening 25a (portion on the insertion section 38 side) and the waste side rotating pivot 26c of the waste toner box 26 is provided in a portion adjacent to the waste side toner reception opening 26a (portion on the insertion section 38 side). As shown in FIG. 12, FIG. 13, and FIG. 15, on the apparatus main frame 1a side, a second pressing mechanism 62 for elastically biasing the waste toner box 26 is provided above the first pressing mechanism 57 for elastically biasing the new toner box 25. The structure of the second pressing mechanism 62 is identical to that of the first pressing mechanism 57.

Description is now given of the procedures for attaching the toner box unit 32 to the process unit 31 and further loading the imaging cartridge 4 onto the apparatus main frame 1a.

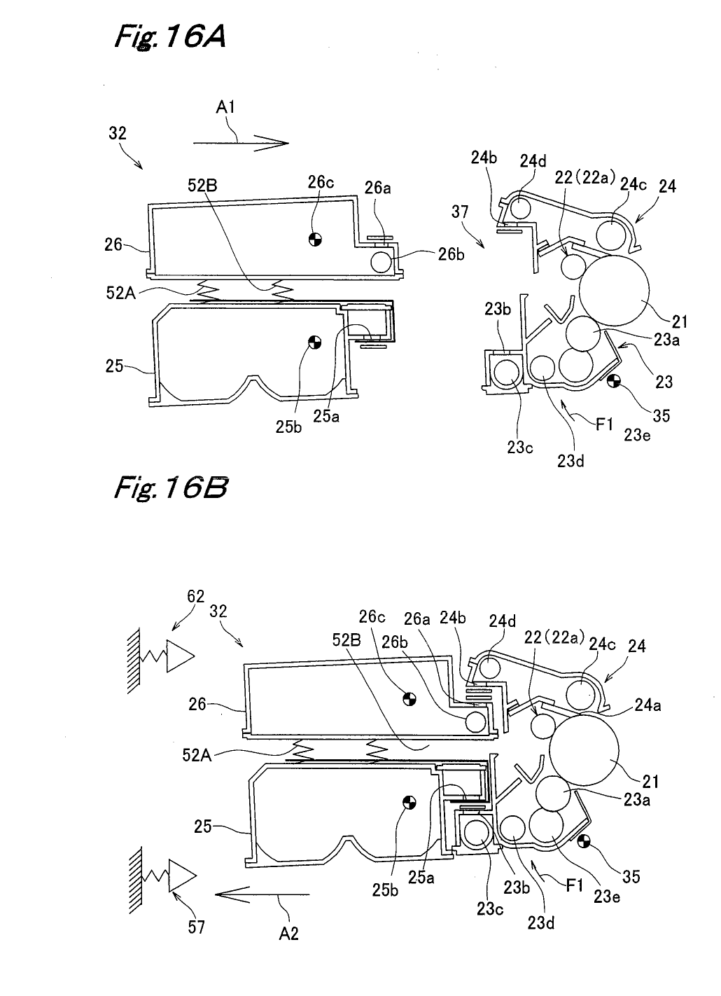

With reference to FIG. 16A, as shown by an arrow “Al”, the insertion section 38 of the toner box unit 32 is inserted into the reception space 37 of the process unit 31. During the insertion, the guide linear protrusions 46A and 46B at the sides of the toner box unit 32 are guided by guide grooves 54A and 54B of the process unit 31, so that the toner box unit 32 is attached to the process unit 31 with maintaining its right posture. Upon complete insertion of the insertion section 38 into the reception space 37, the development side rotating pivot 25b and waste side rotating pivot 26c respectively reach the closed ends of the development side recess hole 34a and the waste side recess hole 33a, by which attachment of the toner box unit 32 to the process unit 31 is completed. In this state, the position of the new toner box 25 and waste toner box 26 with respect to the process unit 31 is preliminarily determined.

Next, as shown by an arrow “A2” in FIGS. 16B, an imaging cartridge 4 is loaded into the apparatus main frame 1a. With reference to FIG. 12, when the imaging cartridge 4 is inserted into a predetermined position in the apparatus main frame 1a, the portion of the lower portion of the new toner box away from the development side toner delivery opening 25a (portion away from the insertion section 38), i.e., the portion positioned on the left-hand side of the development side rotating pivot 25b, is pressed upward by the first pressing mechanism 57 on the apparatus main frame 1a side. By the elastic pressing force exerted by the first pressing mechanism 57, the new toner box 25 is urged to be rotated around the development side rotating pivot 25b. More specifically, as shown by arrow F2 in FIG. 12, with the pressing force coming from the first pressing mechanism 57, the new toner box 25 rotates around the development side rotating pivot 25b in the direction in which the vicinity of the development side toner delivery opening 25a is biased toward the vicinity of the development side toner reception opening 23b of the developing device 23 (clockwise direction in FIG. 12). As a result, the position of the new toner box 25 with respect to the process unit 31 is determined.

Moreover, when the imaging cartridge 4 is inserted into a predetermined position in the apparatus main frame 1a, the portion of the upper portion of the waste toner box 26 away from the waste side toner reception opening 26a (portion away from the insertion section 38), i.e., the portion positioned on the left-hand side of the waste side rotating pivot 26c, is pressed downward by the second pressing mechanism 62 on the apparatus main frame 1a side. By the elastic pressing force exerted by the second pressing mechanism 62, the waste toner box 26 is urged to be rotated around the waste side rotating pivot 26c. More specifically, as shown by an arrow “F4” in FIG. 12, with the pressing force from the second pressing mechanism 62, the waste toner box 26 is urged to be rotated around the development side rotating pivot 25b in the direction in which the vicinity of the waste side toner reception opening 26a is biased toward the vicinity of the waste side toner delivery opening 24b of the cleaning device 24 (counterclockwise direction in FIG. 12). As a result, the position of the waste toner box 26 with respect to the process unit 31 is determined.

The new toner box 25 and waste toner box 26 are coupled to each other by the support mechanism 51 so as to be supported to each other in a manner allowing elastic relative displacement. Accordingly, when the imaging cartridge 4 is loaded into the image forming apparatus body la, the new toner box 25 and waste toner box 26 are enabled to temporarily retreat or escape from an original position, ensuring the successful setting property. Moreover, the elastic force exerted by the helical compression springs 52A and 52B of the support mechanism 51 on the new toner box 25 and waste toner box 26 contributes to the positioning of the new toner box 25 and waste toner box 26 with respect to the process unit 31, so that the new toner box 25 and waste toner box 26 are positioned with respect to the process unit with high degree of accuracy. Further, the development side toner delivery opening 25a of the new toner box 25 and the waste side toner reception opening 26a of the waste toner box 26 are elastically biased by the biasing force exerted by the pressing mechanisms 57 and 62 so as to be brought into close contact with the developing device 23 and the cleaning device 24, thereby preventing leakage and littering of toner. Furthermore, since the development side rotating pivot 25b of the new toner box 25 is accommodated in the development side recess hole 34a provided in the second casing 34 including the developing device 23, there is no loss of the pressing force exerted on the developing device 23 due to the pressing force acting on the new toner box 25 from the first pressing mechanism 57 on the image forming apparatus body 1a side, so that the positioning accuracy of the developing device 23 with respect to the photoconductor 21 can be secured.

Since other structures and operations of the second embodiment are similar to those of the first embodiment, like component members are designated by like reference numerals to omit description.

### Third Embodiment

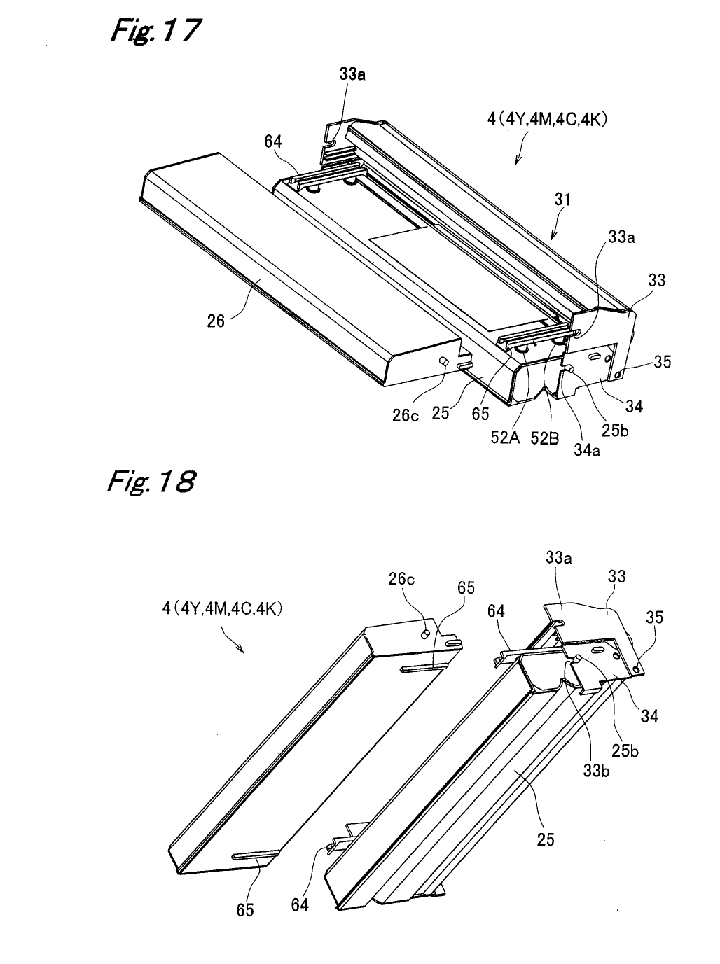

An imaging cartridge 4 according to a third embodiment of the present invention shown in FIGS. 17 and 18 is different in the structure of the support mechanism 51 from the second embodiment. More specifically, whereas the support mechanism 51 in the second embodiment couples the new toner box 25 and the waste toner box 26 to each other in an unremovable manner, a support mechanism 51 in the present embodiment couples the new toner box 25 and waste toner box 26 to each other in a removable or detachable manner.

The lower end sides of the helical compression springs 52A and 52B are coupled to the upper surface of the new toner box 25, while the upper end sides thereof are coupled to a pair of guide rails 64. Each of the guide rails 64 extends in the inserting direction into the process unit 31 (see the arrow “A1” in FIGS. 11 and 16), and is elastically displaceable in vertical direction. Provided on the lower surface of the waste toner box 26 is guide projections 65 which extend in the inserting direction into the process unit 31 and can be inserted into the guide rails 64.

For attaching the toner box unit 32 to the process unit 31, first, the new toner box 25 is attached to the process unit 31. Then, the waste toner box 26 is attached to the process unit 31 with inserting the guide projections 65 into the guide rails 64.

Since other structures and operations of the third embodiment are similar to those of the second embodiment, like component members are designated by like reference numerals to omit description. The support mechanism 51 for detachably coupling the new toner box 25 and waste toner box 26 to each other in a detachable manner can also be applied to the imaging cartridge 4 of the first embodiment as same as the present embodiment.

The present invention is not limited to the embodiments disclosed but includes various modifications. Although the present invention has been explained regarding the printer of the direct transfer type, the present invention can also be applied to image forming apparatuses of indirect transfer type in which a toner image is primarily transferred onto an intermediate transfer belt from respective imaging cartridges and the toner image on the intermediate transfer belt is secondarily transferred onto a recording medium. The present invention is also applicable to image forming apparatuses other than printers, such as copying machines, facsimile machines, and multi-functional machines.

Although the present invention has been fully described in conjunction with preferred embodiments thereof with reference to the accompanying drawings, various changes and modifications are possible for those skilled in the art. Therefore, such changes and modifications should be construed as included in the present invention unless they depart from the intention and scope of the invention as defined by the appended claims.

What is claimed is:

1. An imaging cartridge detachably loaded into an image forming apparatus body, comprising:
a process unit comprising at least an image bearing body, a developing device for developing an electrostatic latent image on the image bearing body to form a toner image, and a cleaning device for collecting toner remaining on the image bearing body after transfer of the toner image;
a new toner box detachably attached to the process unit and adapted to store therein unused toner to be fed to the developing device;
a waste toner box detachably attached to the process unit and adapted to store therein waste toner collected by the cleaning device; and
a support mechanism for coupling the new toner box and waste toner box to each other so as to be supported to each other in a manner allowing elastic relative displacement between the new toner box and waste toner box.

2. An imaging cartridge according to claim 1, wherein upon attachment to the process unit, the new toner box and waste toner box are preliminarily positioned with respect to the process unit, and
wherein at least one of the new toner box and waste toner box is positioned with respect to the process unit by an elastic pressing force exerted by a pressing mechanism on the image forming apparatus body side.

3. An imaging cartridge according to claim 2, wherein one of the new toner box and waste toner box is positioned with respect to the process unit by the elastic pressing force exerted by the pressing mechanism on the image forming apparatus body side, and
wherein the other of the new toner box and waste toner box is positioned with respect to the process unit by an elastic pressing force exerted by the support mechanism.

4. An imaging cartridge according to claim 3, wherein the one toner box is the new toner box,
wherein the other toner box is the waste toner box,
wherein the new toner box comprises a toner delivery opening for delivering the toner to the developing device, and a rotational fulcrum for rotating the new toner box itself by the elastic pressing force exerted by the pressing mechanism in a direction where the toner delivery opening is biased toward the developing device, and
wherein the waste toner box comprises a toner reception opening for receiving the toner from the cleaning device, and a rotational fulcrum for rotating the waste toner box itself by the elastic pressing force exerted by the support mechanism in a direction where the toner reception opening is biased toward the developing device.

5. An imaging cartridge according to claim 4, wherein the process unit comprises at least a first casing for supporting the image bearing body, and a second casing rotatably coupled to the first casing and provided with the developing device, the second casing being elastically pressed in a direction of bringing the developing device close to the image bearing body, and
wherein the rotational fulcrum of the new toner box is arranged in the second casing.

6. An imaging cartridge according to claim 2, wherein both of the new toner box and waste toner box are positioned with respect to the process unit by the elastic pressing force exerted by the pressing mechanism on the image forming apparatus body side.

7. An imaging cartridge according to claim 6, wherein the new toner box comprises a toner delivery opening for delivering the toner to the developing device, and a rotational fulcrum for rotating the new toner box itself by the elastic pressing force exerted by the pressing mechanism on the image forming apparatus body side in a direction where the toner delivery opening is biased toward the developing device, and
wherein the waste toner box comprises a toner reception opening for receiving the toner from the cleaning device, and a rotational fulcrum for rotating the waste toner box itself by the elastic pressing force exerted from the pressing mechanism on the image forming apparatus body side in a direction where the toner reception opening is biased toward the cleaning device.

8. An imaging cartridge according to claim 7, wherein the process unit comprises at least a first casing for supporting the image bearing body, and a second casing rotatably coupled to the first casing and provided with the developing device, the second casing being elastically pressed in a direction of bringing the developing device close to the image bearing body, and
wherein the rotational fulcrum of the new toner box is arranged in the second casing.

9. An imaging cartridge according to claim 1, wherein the support mechanism detachably couples the new toner box and waste toner box to each other.

10. An image forming apparatus, including the imaging cartridge according to claim 1.
